(19) United States
(12) Patent Application Publication
(10) Pub. No.: US 2015/0085848 A1
(43) Pub. Date: Mar. 26, 2015

(54) Method and Apparatus for Controlling Wireless Network Access Parameter Sharing

(71) Applicants: Jukka Pekka Reunamaki, Tampere (FI); Janne Marin, Espoo (FI); Niko Tapani Kiukkonen, Veikkola (FI); Sverre Slotte, Espoo (FI)

(72) Inventors: Jukka Pekka Reunamaki, Tampere (FI); Janne Marin, Espoo (FI); Niko Tapani Kiukkonen, Veikkola (FI); Sverre Slotte, Espoo (FI)

(73) Assignee: Nokia Corporation, Espoo (FI)

(21) Appl. No.: 14/391,406

(22) PCT Filed: Apr. 26, 2012
(86) PCT No.: PCT/FI2012/050413

§ 371 Date: Oct. 9, 2014

(51) Int. Cl. H04W 48/08; H04W 12/08

(52) U.S. Cl. CPC H04W 48/08; H04W 12/08
USPC 370/338

(57) ABSTRACT

In a non-limiting and example embodiment, a method is provided for controlling access to wireless network access parameters, comprising: providing, by an apparatus to a second apparatus, credentials for accessing to a wireless network, detecting, by the apparatus, an identity of a third apparatus, and sending, by the apparatus, a message to the second apparatus to allow to deliver the credentials to the third apparatus.

### FIELD

The present invention relates to controlling sharing of wireless network access parameters.

### BACKGROUND

Local wireless networks, such as IEEE 802.11 WLANs or wireless wide area networks, are very widely used for local wireless Internet connectivity. Majority of private wireless network access points are protected, i.e. they can be hidden and require correct encryption key to be accessed. Various personal communications devices like mobile phones, tablets and laptops are having more and more nomadic users who use their devices increasingly at friends' homes, pubs, cafes and soon also e.g. in private cars. A cellular data connection can be slow, expensive and/or may not be supported.

It is desirable to easily get access rights for available access points also when a user is visiting a friend, for example. The user's friend is likely happy to allow the user to share his wireless network but most likely has security concerns about sharing required connection credentials. Most people do not want to open their network in order to maintain privacy, to avoid increased traffic on their internet connection or to protect from false accusations of piracy. Some advanced access points support separate guest access but these are not very common. Some expert users also set up a guest network with additional routers and access points. A password protected guest network still requires its owner to share the credentials to guests.

### SUMMARY

Various aspects of examples of the invention are set out in the claims.

According to a first embodiment, there is provided a method, comprising: providing, by an apparatus to a second apparatus, credentials for accessing to a wireless network, detecting, by the apparatus, an identity of a third apparatus, and sending, by the apparatus, a message to the second apparatus to allow to deliver the credentials to the third apparatus.

According to a second embodiment, there is provided a method, comprising: receiving, by an apparatus from a second apparatus, credentials for accessing to a wireless network, receiving, by the apparatus from the second apparatus, a message to allow to deliver the credentials to a third apparatus identified by the message, storing, by the apparatus on the basis of the received message, an identifier associated with the third apparatus as an allowed user of the wireless network, and on the basis of the stored information, sending the credentials to the third apparatus requesting access to the wireless network.

According to a third embodiment, there is provided an apparatus configured to carry out the method of the first and/or second embodiment.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a wireless communications system;

FIGS. 2a and 2b illustrate methods according to some embodiments;

FIG. 3 is a signaling chart illustrating wireless network sharing according to an embodiment;

FIG. 4 illustrates network information sharing architecture according to an embodiment; and

FIG. 5 illustrates a mobile communications device according to an embodiment.

### DETAILED DESCRIPTION

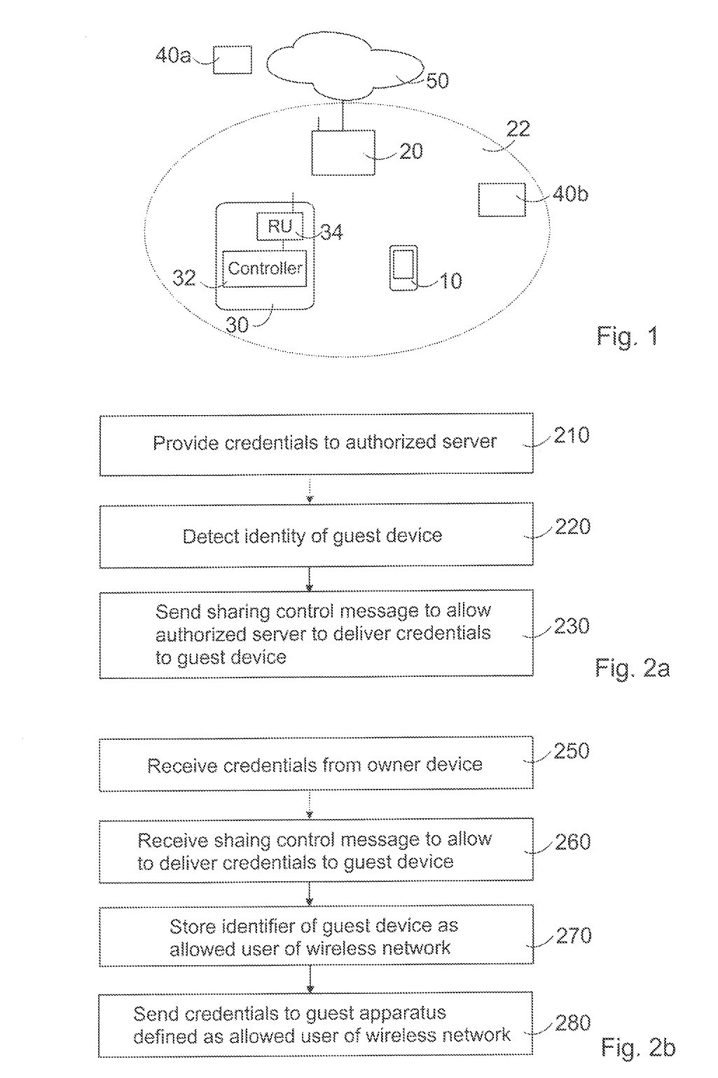

FIG. 1 illustrates an example of a wireless communication system including radio devices, such as devices supporting IEEE 802.11 features. While some wireless network sharing related embodiments are described below with reference to WLANs, it should be appreciated that other embodiments are applicable to sharing access to other wireless networks, such as wireless personal area networks (WPAN), wireless peer-to-peer networks, wireless mesh networks, wireless wide area networks (WAN).

Mobile devices 10, 30 may associate with an access point (AP) or a base station 20. In some embodiments, the devices 10, 30 are IEEE 802.11 WLAN stations (STA) capable of establishing an infrastructure basic service set (BSS) with the AP 20. The AP 20 may be a fixed or mobile AP. The AP 20 typically provides access to other networks 50, e.g. the Internet. In another embodiment, an independent BSS (IBSS) or a mesh BSS (MBSS) is established without a dedicated AP, and in such embodiments the mobile device 10, 30 may be a non-access-point terminal station. There may also be other WLANs or other types of access networks, such as cellular networks, available for the devices 10, 30, via which remote devices 40a, such as network servers, may be connected. One or more further local devices 40b, in the examples below also referred to as server, may be connected to a locally available wired or wireless network.

The mobile device 10, referred hereafter as the guest device, may be visiting a coverage area 22 of the access point 20 owned by a user of mobile device 30, hereafter referred as the owner device. It is to be noted that the owner device herein generally refers to an apparatus which has required credentials, typically in clear text format, for connecting an access point, but the user of which does not necessarily have to actually own the access point.

Credentials for accessing a WLAN by establishing a connection with the AP may comprise at least one of a service set identifier, an encryption type indicator, and an encryption key. However, it is to be appreciated that these are just examples of applicable parameters and the term ‘credentials’ is herewith used broadly to refer to any required parameters required for enabling access to a current or future wireless network. A Bluetooth address needed for connecting Bluetooth device is an example of a parameter for accessing a WPAN. An owner of a wireless network often is not willing to share his network and credentials due to security concerns, does not know the required credentials or is not aware how to setup connection credentials into a device. It is generally desirable to have an easy and trusted method to give access to protected wireless networks, such as WLAN access points.

According to some embodiments of the present invention, an owner device 30 authorizes or delegates at least some wireless network sharing functions to a second apparatus, such as the server 40a, 40b in the examples below. FIGS. 2a and 2b illustrate methods according to some embodiments. These methods of FIGS. 2a and 2b may be applied as control algorithm in apparatuses, such as the owner device 30 and the server 40a, 40b, respectively.

Credentials for accessing to a wireless network are provided 210 to the server 40a, 40b, which is authorized by the owner to share access to the wireless network for guest devices. The credentials may be obtained from WLAN connectivity manager software and transmitted via a radio connection, for example. The server may already have the credentials, in which case the owner device may indicate the credentials/associated wireless network.

An identity of a guest device is detected 220. The identity may be detected on the basis of a request from the guest device 10 in proximity to the owner device 30 or an input from the user of the owner device 30, for example. It is to be appreciated that the identity of the guest device herein refers broadly to an identifier associated with the guest device, such as an equipment identifier, a subscriber identifier, a social media identity, or a user name. Thus, the identity may identify the guest user, and not necessarily a specific guest device.

A sharing control message is sent 230 to the second apparatus to allow to deliver the credentials to the guest device. The message may comprise a request or command to add the guest device in a list of allowed guests. If a sharing delegation service has not earlier been setup between the owner device and the server, the message may comprise further information for establishing the sharing service for the owner device by the server. In another embodiment, the sharing service is established by separate signalling.

With reference to FIG. 2b, credentials for accessing the wireless network are received 250 from the owner device 30. A sharing control message to allow to deliver the credentials to a third apparatus identified by the message is received 260 from the owner device. In another embodiment, the credentials and the identification of allowed device(s) are sent/received in a single message from the owner device 30.

On the basis of the received message, the server may store 270 an identifier associated with the guest device as an allowed user of the wireless network. On the basis of the stored information, which may be referred to as wireless network sharing configuration, the credentials may be sent 280 to the third apparatus requesting access to the wireless network or available credentials.

Thus, the authorized server 40a, 40b may manage local wireless network credentials sharing on behalf of one or more owner devices, and enable access for guest device(s) allowed by the owner. Hence, once authorized, distribution of network access credentials may be arranged without further bothering or requiring the presence of the owner.

The owner device 30 may send one or more parameters for controlling validity of the credentials in the sharing control message 230 or in another sharing control related message to the server. The server controls the use of the credentials on the basis of the received parameter, and may send sharing control information and/or commands to the guest device together with the credentials 280 and/or in a subsequent message. For example, the parameter(s) may comprise at least one of information indicating how long the credentials are valid, information indicating a time period during which the guest device is authorized to access the wireless network, information indicating that all or a subset of allowed devices are not any more allowed to use the credentials, and information indicating need for periodic reauthorization of the credentials. As further examples, the owner device 30 may control the number of times the guest device is able to access the network before the credentials elapse, or control the commissioning of new AP credentials in response to detecting change or modification of the currently applied credentials.

Referring back to FIG. 1, the mobile device 30 may comprise a controller 32 connected to a radio unit (RU) 34. The controller 32 may be configured to control at least some of the features illustrated in FIG. 2a and/or 2b. An apparatus comprising the controller 32 may also be arranged to implement at least some of the further related example embodiments illustrated below.

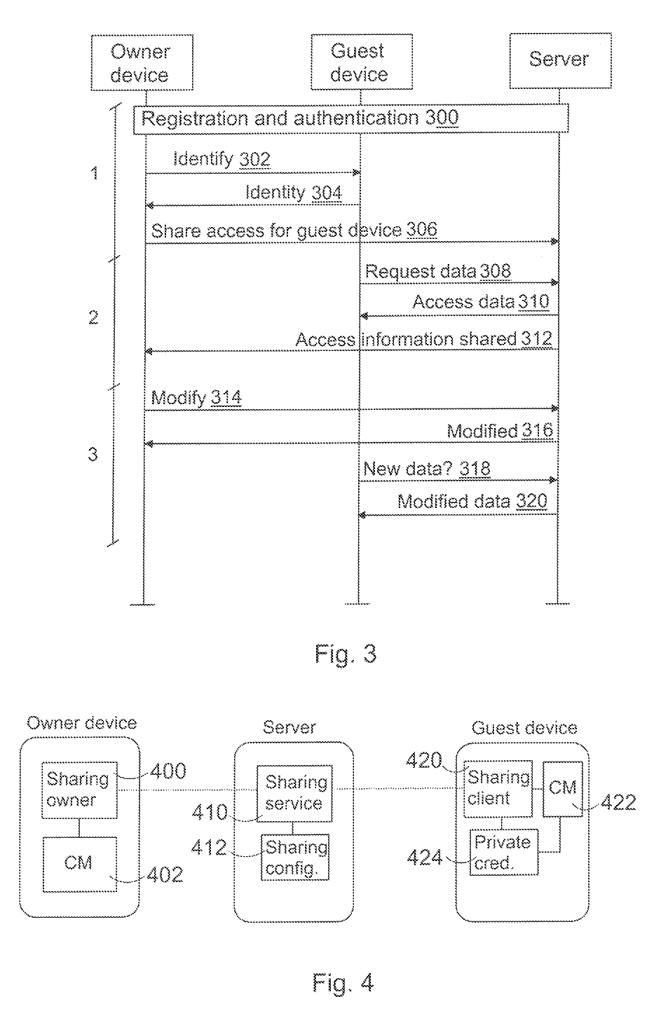

FIG. 3 illustrates an example procedure divided in three stages; 1) receiving the guest device identity and adding the identity to the server 40a, 40b, 2) getting required information from the server for network access, and 3) optional modification of network access parameters.

The owner device 30 and the guest device 10 may first register 300 and authenticate to the server, if not already done beforehand. The credentials may thus be provided 210, 250 to the server.

The owner device may request 302 and receive 304 an identity associated with the guest device by using a local radio technology. The owner device may command 306 the server to add the identified device/user to a (white) list of devices and/or users to which information required for network access is shared. It is to be noted that the identifier from the guest device may represent multiple devices, e.g. the identified user may have several devices, whereby the network access information may be distributed to multiple devices.

The guest device 10 requesting wireless network access connects 308 the server to receive new or modified information. The owner device may have informed the guest device 10 of the server e.g. as a response to the message 304, or in an embodiment the server may contact the guest device.

The server decides based on its configuration whether the needed parameters for network access are delivered to the guest device. The credentials are sent 310 to the authorized guest device. The server may notify 312 the owner device that the network access is distributed to the guest device.

The server maintains information to which devices/users the network access credentials have been distributed. The owner device may modify 314, 316 access rights and/or network credentials later. The changes are reflected 318, 320 to the devices having network access, such as the guest device 10.

Reference is now made to FIG. 4 illustrating example functional entities related to wireless network sharing. The mobile device 30 functioning as the owner device, and the controller 32 thereof, may encompass a sharing service owner application 400, which may be arranged to cause the features of FIG. 2a. The sharing owner application 400 may communicate with a sharing service/server application 410 in the server 40a, 40b and delegate wireless network credentials sharing for the sharing service application 410. The sharing owner application 400 may send wireless network sharing related parameters, such as the network credentials, allowed guest device identifiers and further sharing control parameters, to the sharing service application 410.

The sharing service 410 may maintain a sharing configuration 412 for the wireless network and the sharing owner 400.

The sharing service application 410 may communicate with a client application 420 in the guest device. The sharing service 410 provides the credentials for the sharing client application 420 of the guest device 10 allowed by the sharing owner 400.

It is to be noted that in some embodiments the sharing owner application 400 may communicate with the sharing client 420, e.g. receive an initial request for network sharing with the identity of the guest device. An apparatus may comprise both the sharing owner 400 and the sharing client application 420. For example, it may be that the sharing client 420, the sharing owner application 400, and/or the connectivity management (CM) application 402, 422 are implemented in a common executable program, or in separate executable programs.

In some embodiments, access to the delivered credentials is limited in the server 40a, 40b and/or the guest device 10. Such private credentials may be stored to a protected storage 424, e.g. by applying encryption, hidden storage area, or access-controlled storage area/position. The credentials may be accessible by only predetermined trusted applications, such as a trusted network sharing client application and lower level connectivity management software 422. In particular, the credentials may be stored such that they are not made visible in the user interface of the guest device 10. This enables to provide reasonable trust for the wireless network owner that the credentials cannot be forwarded to unauthorized parties.

In some embodiments, the credentials are transferred in encrypted form. The owner device 30 may send a decryption parameter to server 40a, 40b, which may send it later to the guest device 10 for decrypting the encrypted credentials. In an alternative embodiment, the owner device 30 sends the decryption parameter directly to the guest device 10.

In some embodiments, the owner device 30 defines which wireless networks are available for sharing on the basis of checking to which wireless networks the owner device 30 is connected to, checking wireless networks for which the owner device 30 has credentials, and/or checking which wireless networks are preconfigured to be shareable, for example. The sharing owner application 400 may have a user interface which allows the owner to easily specify which WLAN access point credentials configured in the device can be shared to other devices.

Wireless network configuration information of the owner device 30 may be applied for network sharing. For example, the user of the owner device 30 may decide to share all WLAN access points 20 which are readable in device's network configuration maintained by CM software 402. It is to be noted that the owner device 30 may also comprise, in a protected storage, private network information, which may not be shared further. After the user has authorized sharing, the credentials may be provided automatically to the server 40a, 40b and thereafter to authorized guest devices. Thus, the user does not have to find network parameter configuration in order to provide access to her friend. This sharing can be set to be active all the time, and credentials may be automatically provided for an authorized guest device 10 upon a later visit.

The user interface of the owner device 30 and the owner application 400 may provide an input mode allowing the user to specify users allowed to share the wireless network and receive the credentials. For example, allowed guests may be selected/entered by applying a contact book of the owner device 30, from a social media service/application, etc. Allowed guest identifiers are delivered to the server 40a, 40b, and may also be stored in the memory of the owner device 30. The server 40a, 40b may check the allowed guest identifiers in the sharing configuration 412 in response to receiving a guest access request from the sharing client 420. The sharing service 410 may automatically cause sending of the credentials to the guest device 10 if an identifier associated with the guest device 10 is stored in the guest identifiers.

The sharing client application 420 may inform a user of the guest device 10 of available wireless networks. The sharing client application 420 may request the credentials from the sharing owner 400 or the sharing service 410 after detecting a trigger input for accessing an available wireless network. The sharing client application 420 may be arranged to automatically take care of any necessary actions for obtaining and setting the required wireless network access configuration, and trigger establishment of a connection to the wireless network AP 20. This substantially facilitates use of protected networks for non-professional users.

When the guest device 10 is no longer connected to the wireless network, the stored credentials may be removed automatically by the sharing client application 420 or the connectivity management SW 422. The credentials may be prevented from being used or removed from the protected storage 424 after detecting one or more triggers for removal, such as detecting the apparatus disconnecting from the wireless network, detecting expiry of a validity period of the credentials, and/or detecting that a credentials refreshment message or an authorization message (from the owner device or a further device controlling use of the credentials) has not been received. A predefined disconnection time period may be applied before the credentials are deleted after detecting the removal trigger, to prevent accidental removal.

The sharing owner 400 and/or sharing service 410 may be configured to cause removal of the credentials in the guest device 10, e.g. by sending a control message for removing the credentials to the sharing client 420. A user interface of the guest device 10 and/or the owner device 30 may further provide an option for a user to cause removal of the credentials in the protected storage 424.

After removal of the credentials, the guest device 10 may need to again connect the owner device 30 or the server 40a, 40b in order to use the wireless network. The owner application 400 UI may enable the owner to set a permanent access or an access until further notice for the guest device, and if necessary, new credentials may be provided or access reauthorized by the server 40a, 40b without bothering the owner.

The guest device 10 may be required to check or renew its permission from the server 40a, 40b and/or owner device 30, e.g. at defined time instants. The server 40a, 40b may collect statics about when and which user has used the access point, enabling the owner to monitor the guest access usage.

The owner device 30 may be communicating with different radio connections with the guest device 10 and the server 40a, 40b. Examples of suitable connections include, but are not limited to, a near-field connection (NFC) to a mobile communications device, a Bluetooth connection to a mobile communications device, and a wireless local area network connection to a mobile communications device. In a further example, the server may be a remote server 40a, with which the owner device may communicate via a cellular connection. In one example, the network sharing is provided by a Bluetooth (BT) service. For example, sharing service information may be indicated in a BT Extended Inquiry Response field, which enables to speed up the discovery process.

In some embodiments the provision of the credentials to the guest device 10 is allowed 230 after the guest device is brought to touch detection proximity to the owner device 30. The touch detection proximity generally refers to sensing the devices to be very close to each other (contactless) or physically touching each other. For example, the touch detection proximity may refer to proximity enabling NFC connectivity. In an embodiment, upon detecting a user input for getting access to the WLAN, the guest device 10 may begin to search for devices in close proximity and the sharing client application may advice the user to touch the owner's device 30 with the guest device 10. In another example, the network sharing is further facilitated such that credentials are provided when the guest device 10 is detected to touch the owner device 30, without requiring UI actions from the user. This may be done without having a priori knowledge on WLAN existence.

According to an embodiment, BT based proximity detection is applied for triggering sharing of the wireless network and the credentials. The BT touch feature enables to detect another BT device in touch detection proximity, on the basis of received signal strength information (RSSI) associated with received BT responses from neighbouring BT devices.

For example, when the sharing client 400 detects a need for accessing an available WLAN, e.g. on the basis of a user input, it connects to Bluetooth service and initiates a BT touch inquiry. Upon receiving a BT touch inquiry, the owner device 30 responds with a BT touch inquiry response. Received inquiry responses are filtered according to RSSI levels. When an owner device is found with RSSI level above a predefined threshold value, which may be set so that touch is required, a BT connection is established between the client device and the owner device. In response to detecting the BT touch event, the sharing owner application 400 may initiate the wireless network sharing. The owner device 30 may receive 220 the identity of the guest device via a Bluetooth sharing service, and the sharing owner 400 may send 230 the sharing control message to the sharing service 410 to allow the delivery of the credentials to the identified guest device. The user of the owner device 30 may also be prompted to confirm networks sharing for the guest device 10.

In an alternative embodiment, the owner device 30 sends the credentials directly to the guest device after detecting that the wireless network can be shared for the guest device (e.g. based on owner device user confirmation). The owner device 30 may inform the server 40a, 40b about distribution of the network credentials. The server may still maintain network sharing configuration and e.g. distribute credentials also for guest user's other devices. In a still further embodiment, some credentials are sent to the guest device 110 from the owner device 30 and some from the server 40a, 40b.

Embodiments of the present invention and means to carry out these embodiments in an apparatus, such as the mobile device 10, 30 and/or server 40a, 40b, may be implemented in software, hardware, application logic or a combination of software, hardware and application logic. In an example embodiment, the application logic, software or an instruction set is maintained on any one of various conventional computer-readable media. It is to be noted that at least some of the above-illustrated features may be applied in devices configured to operate as wireless network access point 20, such as an IEEE 802.11 WLAN AP. For example, at least some of the above-illustrated server features and the sharing service 410 may be arranged in such apparatus. In another example, a mobile terminal device, such as the owner device 30, may be arranged to operate also as a wireless network access point.

In one example embodiment, there may be provided circuitry configured to provide at least some functions illustrated above, such as the features illustrated in FIG. 2a and/or 2b. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

Although single enhanced entities were depicted above, it will be appreciated that different features may be implemented in one or more physical or logical entities. For instance, the apparatus may comprise a specific functional module for carrying one or more of the blocks in FIG. 2a and/or 2b. In some embodiments, a chip unit or some other kind of hardware module is provided for controlling a radio device, such as the mobile device 10, 30.

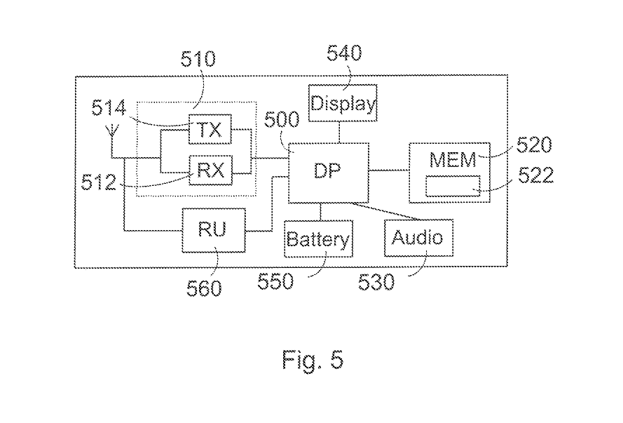

FIG. 5 is a simplified block diagram of high-level elements of a mobile communications device according to an embodiment. The device may be configured to carry out at least some of the functions illustrated above for the mobile device 10 and/or 30.

In general, the various embodiments of the device can include, but are not limited to, cellular telephones, personal digital assistants (PDAs), laptop/tablet computers, digital book readers, imaging devices, gaming devices, media storage and playback appliances, Internet access appliances, as well as other portable units or terminals that incorporate wireless communications functions.

The device comprises a data processing element DP 500 with at least one data processor and a memory 520 storing a program 522. The memory 520 may be implemented using any data storage technology appropriate for the technical implementation context of the respective entity. By way of example, the memory 520 may include non-volatile portion, such as electrically erasable programmable read only memory (EEPROM), flash memory or the like, and a volatile portion, such as a random access memory (RAM) including a cache area for temporary storage of data. The DP 500 can be implemented on a single-chip, multiple chips or multiple electrical components. The DP 500 may be of any type appropriate to the local technical environment, and may include one or more of general purpose computers, special purpose computers (such as an application-specific integrated circuit (ASIC) or a field programmable gate array FPGA), digital signal processors (DSPs) and processors based on a multi-processor architecture, for instance.

The device may comprise at least one radio frequency transceiver 510 with a transmitter 514 and a receiver 512. However, it will be appreciated that the device is typically a multimode device and comprises one or more further radio units 560, which may be connected to the same antenna or different antennas. By way of illustration, the device may comprise radio units 510 to operate in accordance with any of a number of second, third and/or fourth-generation communication protocols or the like. For example, the device may operate in accordance with one or more of GSM protocols, 3G protocols by the 3GPP, CDMA2000 protocols, 3GPP Long Term Evolution (LTE) protocols, wireless local area network protocols, such as IEEE 802.11 or 802.16 based protocols, short-range wireless protocols, such as the Bluetooth, NFC, ZigBee, Wireless USB, and the like.

The DP 500 may be arranged to receive input from UI input elements, such as an audio input circuit connected to a microphone and a touch screen input unit, and control UI output, such as audio circuitry 530 connected to a speaker and a display 540 of a touch-screen display. The device also comprises a battery 550, and may also comprise other UI output related units, such as a vibration motor for producing vibration alert.

It will be appreciated that the device typically comprises various further elements, such as further processor(s), further communication unit(s), user interface components, a media capturing element, a positioning system receiver, sensors, such as an accelerometer, and a user identity module, not discussed in detail herein. The device may comprise chipsets to implement at least some of the high-level units illustrated in FIG. 5. For example, the device may comprise a power amplification chip for signal amplification, a baseband chip, and possibly further chips, which may be coupled to one or more (master) data processors.

An embodiment provides a computer program embodied on a computer-readable storage medium. The program, such as the program 522 in the memory 520, may comprise computer program code configured to, with the at least one processor, cause an apparatus, such as the device 10, 20, 30 or the device of FIG. 5, to perform at least some of the above-illustrated network access parameter sharing related features illustrated in connection with FIGS. 2a to 4. In the context of this document, a “computer-readable medium” may be any media or means that can contain, store, communicate, propagate or transport the instructions for use by or in connection with an instruction execution system, apparatus, or device, such as a computer, with some examples of a computer being described and depicted in connection with FIG. 5. A computer-readable medium may comprise a tangible and non-transitory computer-readable storage medium that may be any media or means that can contain or store the instructions for use by or in connection with an instruction execution system, apparatus, or device, such as a computer.

Although the specification refers to “an”, “one”, or “some” embodiment(s) in several locations, this does not necessarily mean that each such reference is to the same embodiment(s), or that the feature only applies to a single embodiment. Single features of different embodiments may also be combined to provide other embodiments. If desired, at least some of the different functions discussed herein may be performed in a different order and/or concurrently with each other. Furthermore, if desired, one or more of the above-described functions may be optional.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
providing, by an apparatus to a second apparatus, credentials for accessing to a wireless network,
detecting, by the apparatus, an identity of a third apparatus, and
sending, by the apparatus, a message to the second apparatus to allow to deliver the credentials to the third apparatus.

2. The method of claim 1, wherein the apparatus detects the identity of the third apparatus by receiving the identity of the third apparatus from the third apparatus requesting to be a guest user of the wireless network.

3. The method of claim 1, wherein the apparatus delegates sharing of the credentials to the second apparatus and sends to the second apparatus at least one parameter for controlling validity of the credentials in said message to allow to deliver the credentials or in another sharing control message.

4. The method of claim 3, wherein the at least one parameter comprises at least one of information indicating how long the credentials are valid, information indicating a time period during which the third apparatus is authorized to access the wireless network, information indicating that all or a subset of allowed devices are not any more allowed to use the credentials, and information indicating need for periodic reauthorization of the credentials.

5. (canceled)

6. The method of claim 1, wherein the credentials are in encrypted form, and
the apparatus sends at least one decryption parameter to the second apparatus or the third apparatus for decrypting the encrypted credentials.

7. The method of claim 1, wherein the apparatus is communicating with a first radio technology with the second apparatus and with a second radio technology with the third apparatus, wherein the second radio technology is at least one of a near-field connection, a Bluetooth connection, and a wireless local area network connection.

8. (canceled)

9. The method of claim 1, wherein the apparatus sends said message to allow to deliver the credentials after detecting the third apparatus in touch detection proximity to the apparatus.

10-11. (canceled)

12. The method of claim 1, wherein the credentials are wireless local area network credentials comprising a service set identifier, encryption type, and an encryption key.

13. A method, comprising:
receiving, by an apparatus from a second apparatus, credentials for accessing to a wireless network,
receiving, by the apparatus from the second apparatus, a message to allow to deliver the credentials to a third apparatus identified by the message,
storing, by the apparatus on the basis of the received message, an identifier associated with the third apparatus as an allowed user of the wireless network, and
on the basis of the stored information, sending the credentials to the third apparatus requesting access to the wireless network.

14. The method of claim 13, wherein the apparatus receives from the second apparatus at least one parameter for controlling validity of the credentials in said message to allow to deliver the credentials or in another sharing control message, and
the apparatus controls the use of the credentials on the basis of the received parameter.

15. The method of claim 14, wherein the at least one parameter comprises at least one of information indicating how long the credentials are valid, information indicating a time period during which the third apparatus is authorized to access the wireless network, information indicating that all or a subset of allowed devices are not any more allowed to use the credentials, and information indicating need for periodic reauthorization of the credentials.

16. (canceled)

17. An apparatus, comprising:
at least one processor; and
at least one memory including computer program code,
the at least one memory and the computer program code configured to, with the at least one processor, cause the apparatus at least to:
provide to a second apparatus credentials for accessing to a wireless network,
detect an identity of a third apparatus, and
send a message to the second apparatus to allow to deliver the credentials to the third apparatus.

18. (canceled)

19. The apparatus of claim 17, wherein the apparatus is configured to detect the identity of the third apparatus by receiving the identity of the third apparatus from the third apparatus requesting to be a guest user of the wireless network.

20. The apparatus of claim 17, wherein the apparatus is configured to delegate sharing of the credentials to the second apparatus and send to the second apparatus at least one parameter for controlling validity of the credentials in said message to allow to deliver the credentials or in another sharing control message.

21. The apparatus of claim 20, wherein the at least one parameter comprises at least one of information indicating how long the credentials are valid, information indicating a time period during which the third apparatus is authorized to access the wireless network, information indicating that all or a subset of allowed devices are not any more allowed to use the credentials, and information indicating need for periodic reauthorization of the credentials.

22. (canceled)

23. The apparatus of claim 17, wherein the credentials are in encrypted form, and
the apparatus is configured to send at least one decryption parameter to the second apparatus or the third apparatus for decrypting the encrypted credentials.

24. The apparatus of claim 17, wherein the apparatus is configured to communicate with a first radio technology with the second apparatus and with a second radio technology with the third apparatus, wherein the second radio technology is at least one of a near-field connection, a Bluetooth connection, and a wireless local area network connection.

25. (canceled)

26. The apparatus of claim 17, wherein the apparatus configured to send said message to allow to deliver the credentials after detecting the third apparatus in touch detection proximity to the apparatus.

27-28. (canceled)

29. The apparatus of claim 17, wherein the credentials are wireless local area network credentials comprising a service set identifier, encryption type, and an encryption key.

30. The apparatus of claim 17, wherein the apparatus is at least one of a chipset for a mobile communications device and a mobile communications terminal device comprising a transceiver for communicating according to a wireless local area network standard.

31. (canceled)

32. An apparatus, comprising:
at least one processor; and
at least one memory including computer program code,
the at least one memory and the computer program code configured to, with the at least one processor, cause the apparatus at least to:
receive from a second apparatus, credentials for accessing to a wireless network,
receive from the second apparatus, a message to allow to deliver the credentials to a third apparatus identified by the message,
store, on the basis of the received message, an identifier associated with the third apparatus as an allowed user of the wireless network, and
send the credentials to the third apparatus requesting access to the wireless network on the basis of the stored information.

33. (canceled)

34. The apparatus of claim 32, wherein the apparatus is configured to receive from the second apparatus at least one parameter for controlling validity of the credentials in said message to allow to deliver the credentials or in another sharing control message, and
the apparatus is configured to control the use of the credentials on the basis of the received parameter.

35. The apparatus of claim 34, wherein the at least one parameter comprises at least one of information indicating how long the credentials are valid, information indicating a time period during which the third apparatus is authorized to access the wireless network, information indicating that all or a subset of allowed devices are not any more allowed to use the credentials, and information indicating need for periodic reauthorization of the credentials.

36. (canceled)

37. The apparatus of claim 32, wherein the apparatus is a mobile communications terminal device comprising a transceiver for communicating according to a wireless local area network standard.

38-41. (canceled)
